(19) United States
(12) Patent Application Publication
(10) Pub. No.: US 2008/0080951 A1
(43) Pub. Date: Apr. 3, 2008

(54) Screw with a drilling tail

(76) Inventor: Teng-Hung Lin, Kaohsiung Hsien (TW)

Correspondence Address: TENG-HUNG LIN, 235 Chung - Ho, Box 8-24, Taipei, omitted

(21) Appl. No.: 11/516,450

(22) Filed: Sep. 7, 2006

(51) Int. Cl. F16B 25/10

(52) U.S. Cl. 411/387.6

(57) ABSTRACT

A screw with a drilling tail comprises: a screw head, a drilling tail, a rod portion between the screw head and the drilling tail, and at least one first threads on the rod portion, wherein the helix angle at one end of each thread near the drilling tail becomes larger than the helix angle at other portion of the thread so as to form a guide thread section which covers a range not over half circle of the rod portion; and a distal end of the guide thread section is at an upper end of the drilling tail. There is one or two first threads. The screw with a drilling tail further comprises a second thread between the screw head and the at least one first thread.

### FIELD OF THE INVENTION

The present invention relates to screws, and particularly to a screw with a drilling tail, which can remove dregs in operation quickly and effectively, wherein the helix angle at one end of each thread near the drilling tail becomes larger than the helix angle at other portion of the thread so as to form a guide thread section which covers a range not over half circle of the rod portion; and a distal end of the guide thread section is at an upper end of the drilling tail.

### BACKGROUND OF THE INVENTION

To cause the screw to be screwed into an object quickly, the problem of removing the dregs is an important concern. It also affects the force necessary to be applied in operation. If the dregs are removed quickly, the twisting force is smaller. Thus there are many developments being aimed at the removing of dregs.

In some improved designs, other threads which have forms different from the original threads are designed in some sections of the screws so as to increase the function of removing dregs. However, this thread and the original thread are intersected and thus it forms many intersect sections which generates resisting force for removing dregs. Thus, the drilling speed is increased.

### SUMMARY OF THE INVENTION

Accordingly, the primary object of the present invention is to provide a screw with a drilling tail, which can remove dregs in operation quickly and effectively.

To achieve above object, the present invention provides a screw with a drilling tail which comprises: a screw head, a drilling tail, a rod portion between the screw head; a drilling tail, and at least one first threads on the rod portion, wherein the helix angle at one end of each thread near the drilling tail becomes larger than the helix angle at other portion of the thread so as to form a guide thread section which covers a range not over half circle of the rod portion; and a distal end of the guide thread section is at an upper end of the drilling tail. There is one or two first threads. The screw with a drilling tail further comprises a second thread between the screw head and the at least one first thread.

The various objects and advantages of the present invention will be more readily understood from the following detailed description when read in conjunction with the appended drawing.

### BRIEF DESCRIPTION OF THE DRAWINGS

FIG. 1 shows a front view of the first embodiment of the present invention.

FIG. 2 shows a rear view of the first embodiment of the present invention.

FIG. 3 shows a front view of the second embodiment of the present invention.

FIG. 4 shows a rear view of the second embodiment of the present invention.

FIG. 5 shows a front view of the third embodiment of the present invention.

FIG. 6 shows a rear view of the third embodiment of the present invention.

FIG. 7 shows a front view of the fourth embodiment of the present invention.

FIG. 8 shows a rear view of the fourth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

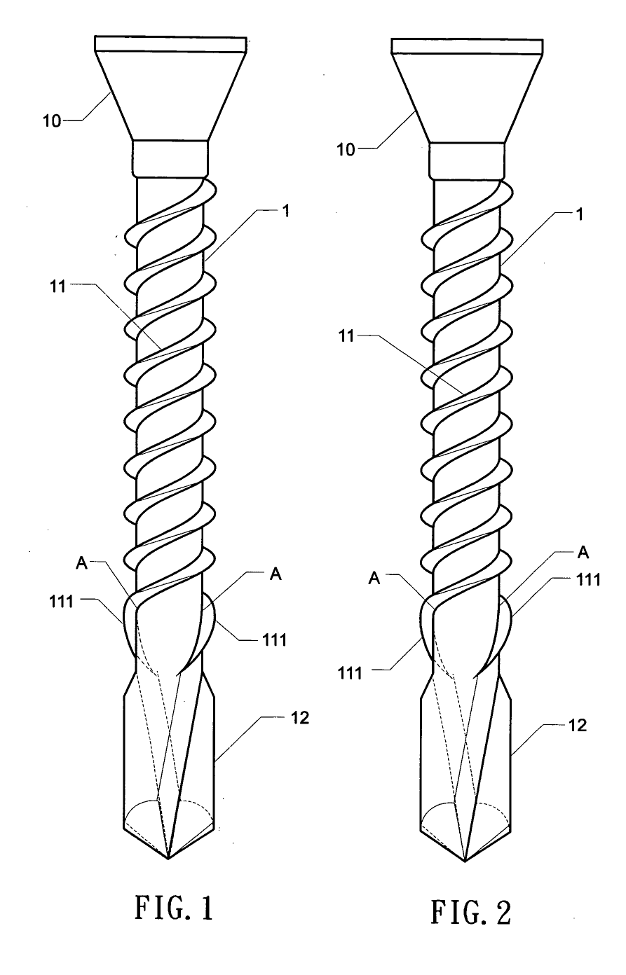

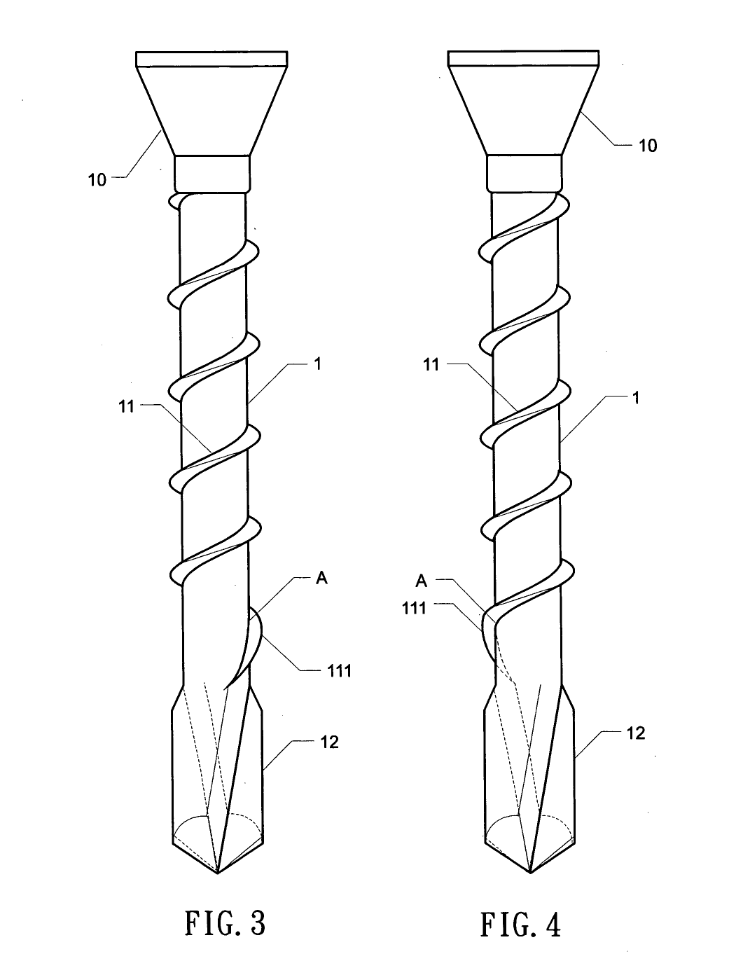

Referring to FIGS. 1 to 3, the screw with a drilling tail is illustrated. The present invention has the following elements.

In FIGS. 1 and 2, the screw has a screw head 10, a drilling tail 12, a rod portion 1 between the screw head 10 and the drilling tail 12, and two threads 11 on the rod portion 1. The helix angle A at one end of each thread 11 near the drilling tail 12 becomes larger than the helix angle at other portion of the thread 11 so as to form a guide thread section 111 which covers a range not over half circle of the rod portion 1. A distal and of the guide thread section 111 is at an upper end of the drilling tail 12.

Thus, dregs in screwing will fall into the gaps between the threads, but the guide thread section 111 will make the dregs move to the drilling tail 12 quickly so that the drilling operation can be performed easily.

Referring to FIG. 3, it illustrates another embodiment of the present invention, in that only one thread 11 is used. The thread 11 also has a guide thread section 111 which has a larger helix angle at the end near the drilling tail 12. The extension of the guide thread section 111 is smaller than one half circle of the rod portion 1.

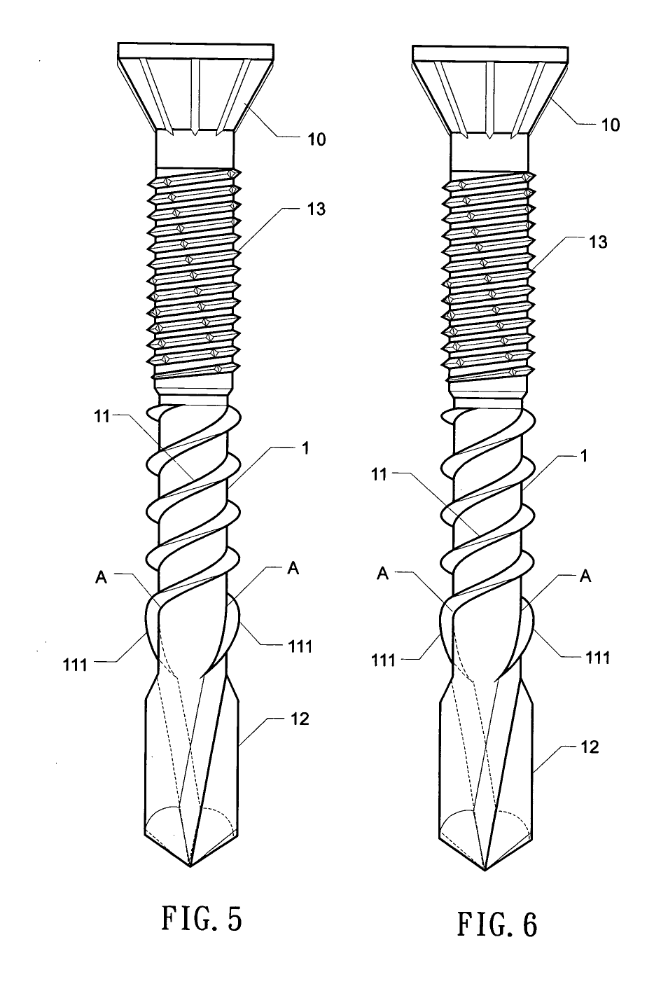

Referring to FIGS. 5 and 6, another embodiment of the present invention is illustrated. In this embodiment, those identical to the above mentioned embodiment shown in FIGS. 1 and 2 will not be further described herein. Only those differences are disclosed. In this embodiment, a third thread 13 is installed between the screw head 10 and the two threads 11. Thus, dregs in screwing will fall into the gaps between the threads, but the guide thread section 111 will make the dregs move to the drilling tail 12 quickly so that the drilling operation can be performed easily.

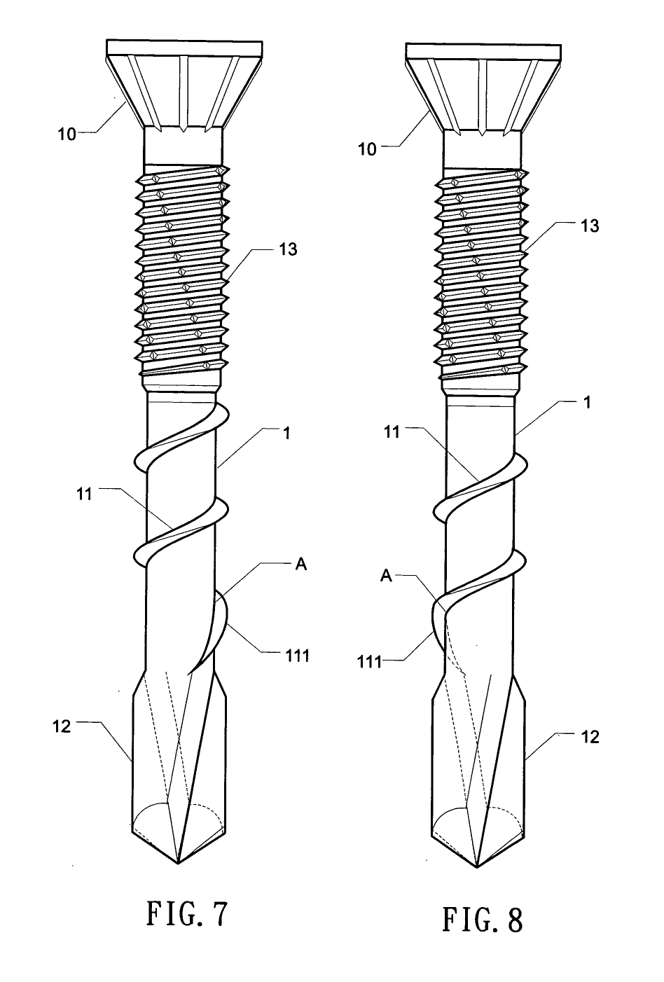

Referring to FIGS. 7 and 8, a fourth embodiment of the present invention. This embodiment is identical to the embodiment shown in FIGS. 5 and 6, but only one thread 11 is used. It has the same effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screw with a drilling tail, comprising:
a screw head,
a drilling tail,
a rod portion between the screw head and the drilling tail; and
at least one first threads on the rod portion, wherein the helix angle at one end of each thread near the drilling tail becomes larger than the helix angle at other portion of the thread so as to form a guide thread section which covers a range not over half circle of the rod portion; and a distal end of the guide thread section is at an upper end of the drilling tail.

2. The screw with a drilling tail as claimed in claim 1, wherein there is only one first thread.

3. The screw with a drilling tail as claimed in claim 1, wherein there are two second threads.

4. The screw with a drilling tail as claimed in claim 1, further comprising a second thread between the screw head and the at least one first thread.

5. The screw with a drilling tail as claimed in claim 1, wherein there is only one first thread.

6. The screw with a drilling tail as claimed in claim 1, wherein there are two second threads.
